(19) United States
(12) Patent Application Publication
(10) Pub. No.: US 2024/0181673 A1
(43) Pub. Date: Jun. 6, 2024

(54) CEMENTITIOUS AND WATER-BASED EPOXY 3D PRINTING MORTAR AND METHODS FOR MAKING THE SAME

(71) Applicant: Miles Petchler, Houston, TX (US)

(72) Inventor: Miles Petchler, Houston, TX (US)

(21) Appl. No.: 18/287,848

(22) PCT Filed: Apr. 22, 2022
(86) PCT No.: PCT/US2022/026063

§ 371 Date: Oct. 20, 2023

Related U.S. Application Data
(60) Provisional application No. 63/258,283, filed on Apr. 22, 2021.

(51) Int. Cl. B28B 1/00; B33Y 10/00; B33Y 70/10; B33Y 80/00; C04B 14/06; C04B 22/06; C04B 24/12; C04B 24/28; C04B 28/02; C04B 111/00; C08G 59/24; C08G 59/42; C08G 59/50

(52) U.S. Cl. CPC B28B 1/001; C04B 14/06; C04B 22/064; C04B 24/121; C04B 24/281; C04B 28/02; C08G 59/245; C08G 59/42; C08G 59/50; B33Y 10/00; B33Y 70/10; B33Y 80/00; C04B 2111/00181

(57) ABSTRACT

A method for forming a structure through three-dimensional (3D) printing, the method comprising applying through a 3D printing apparatus one or more layers of a mortar composition, in which the mortar composition comprises a mortar powder and one or more epoxies. In addition, a mortar composition comprising a mortar powder and one or more epoxies for use in forming a structure through three-dimensional printing. The mortar powder may comprise a cement, such as a hydraulic cement, and an aggregate. The mortar powder may further comprise one or more admixtures. The one or more epoxies may comprise a polymeric resin, and may be bisphenol-based or water-based. Further, the mortar composition may also comprise a curing agent.

### CROSS-REFERENCE TO RELATED APPLICATION

This application claims the benefit of priority to U.S. Provisional Application No. 63/258,283, filed on Apr. 22, 2021, which is herein incorporated by reference in its entirety for all purposes.

### BACKGROUND OF THE INVENTION

Concrete and mortar are durable and strong materials used in many construction applications. They generally refer to a composition of cement, aggregate, and admixtures in the form of a powder. When mixed with water, concrete and mortar form a heterogeneous paste which hardens into a stone-like substance. These materials are renowned for high compressive strength, making them useful for constructing load bearing foundations, footings, beams, and walls. However, concrete and mortar are known to have limited tensile and flexural strength, making them unsuitable for supporting heavy loads in open space, such as in cantilever applications (e.g., as seen with bridges).

Three-dimensional printing technology (3D printing), also referred to as “additive manufacturing,” is a growth area for the construction industry. The premise of this technology is the use of a device capable of fabricating, depositing, extruding, or drawing specialized materials to produce an object based on a computer-aided design file. 3D printing has seen use in the construction industry to produce structural elements or buildings out of specialized cement-based concrete and mortar (Romdhane & El-Sayegh, 2020).

Direct ink writing (DIW) is a method that entails the use of a 3D printing apparatus to deposit numerous layers of a specialized material, sometimes referred to as “ink” to create an object. The ink is a liquid or gel-like substance that solidifies after being deposited in order to accept another layer. In the case of construction 3D printing, the ink is typically a preparation of concrete or mortar.

Another method referred to as “contour crafting” entails the use of a 3D printing apparatus to deposit numerous layers of moldable specialized material to create an object. A 3D printing material's moldability refers to its property to be formed with fine detail after being deposited as a layer. In the case of construction 3D printing, smoothing trowels are typically employed near the nozzle of the 3D printing apparatus, to produce an improved finish. U.S. Pat. No. 8,801,415 describes a trowel design for contour crafting.

The materials utilized, and the proportions of each material in a preparation of concrete or mortar, are referred to as the “mix design.” A challenge with the mix design for 3D printing concrete and mortar is present with the rheology, or working properties, of the material.

The working properties of concrete or mortar pertain to the flow, slump, and consistency of freshly mixed material. Flow refers to the ability of a preparation of concrete or mortar to act like a liquid. Slump refers to the ability of a preparation of concrete or mortar to act like a solid and resist flow. Consistency refers to the ability of a preparation of concrete or mortar to resist segregation of its constituents.

Freshly mixed 3D printing concrete or mortar requires specific working properties in order to be useful. A useful 3D printing concrete or mortar should be able to flow like a liquid, so that it can be pumped to the printing apparatus, but once deposited, acts like a solid so that another layer may be printed atop it to produce an object. Proper mix design for 3D printing concrete and mortar entails the use of appropriate cements, aggregates, and admixtures.

U.S. Pat. No. 10,913,683 describes a composition for a 3D printing comprising cement, aggregate, and admixtures, in which the admixtures comprise two thickeners in the form of a nano-clay and hydroxyethylcellulose, a water reducer, and defoamer. The reference also describes methodology for using the composition for 3D printing to create structural elements.

Chinese Patent Publication No. 104891891 describes a composition for a 3D printing comprising cement, aggregate, and admixtures. The admixtures comprise supplementary cementitious materials as fly ash, silica fume, or blast slag, water reducer, accelerator, air entrainer, pumping aid, water repellent, thickener, and fiber.

U.S. Patent Publication No. 2018/0057405 describes a composition for a 3D printing concrete comprising cement, aggregate, and admixtures, in which the admixtures comprise supplementary cementitious materials as fly ash and silica fume, a thickener as clay, water reducer, pumping aid, and shrinkage reducer. A further embodiment of the invention describes the use of fiber as an additional admixture.

PCT Publication No. WO 2017/181323A1 describes a composition of epoxy, reactive amine curing agent, and cement, with particular applications as a grout, mortar, or floor coating.

Chinese Patent Publication No. 103951352 describes a composition of a waterborne epoxy, aqueous reactive amine curing agent, and cement as a slurry/mortar.

U.S. Patent Publication No. 2011/0166259 describes a composition of epoxy, water-soluble reactive amine curing agent, and cement as a material described as “epoxy cement concrete.”

Japanese Patent No. 2808223 describes a composition of epoxy, reactive amine curing agent, and cement as a waterproof coating.

U.S. Pat. No. 3,798,191 describes a composition of epoxy, reactive amine curing agent, cement, and pozzolan (also known as supplementary cementitious materials, or SCM) as a material for construction applications. U.S. Pat. No. 3,198,758 describes a composition of epoxy, reactive amine curing agent, cement, and animal glue.

PCT Publication No. WO 2018/130913 describes an apparatus and method pertaining to pumping a preparation of concrete where admixtures may be incorporated by an in-line mixing element. Such an apparatus can be used to incorporate a thickening admixture to a preparation of concrete while pumping, and prior to placement, to result in a flowable, high slump mix design.

The art identified herein opines on the use of cement-based compositions for 3D printing, as well as cement and epoxy systems for coatings, grouts, and mortars. However, concrete or mortar based on cement with added epoxy and curing agent is not specifically described for 3D printing applications.

In addition, buildings or structural elements that utilize 3D printing technology often require rebar or mesh reinforcement to be building code compliant. The need to fortify 3D printing concrete and mortar is a disadvantage present with the technology; it requires labor to proactively install steel reinforcement while construction (printing) is in progress, or after a print has been completed. Installing reinforcement during printing poses a worker safety issue, as they are in close proximity to the 3D printing apparatus while it is in motion. In both scenarios of installing reinforcement, labor is also required, which increases costs.

Therefore, there is a need in the art for a concrete or mortar composition for use with 3D printing technology that provides the appropriate working properties for construction.

### SUMMARY OF THE INVENTION

The present application is directed to the use of a mortar composition that includes an epoxy resin and curing agent for 3D printing applications.

In one aspect, the present invention relates to a method for forming a structure through three-dimensional (3D) printing, the method comprising applying through a 3D printing apparatus one or more layers of a mortar composition, in which the mortar composition comprises a mortar powder and one or more epoxies.

In another aspect, the present invention relates to a mortar composition comprising a mortar powder and one or more epoxies for use in forming a structure through three-dimensional printing.

The mortar powder may comprise cement and aggregate. In some embodiments, the cement comprises a hydraulic cement. In certain embodiments, the cement comprises at least about 50% calcium silicates by weight, or at least about 60% calcium silicates by weight. In particular embodiments, the cement further comprises calcium aluminates, calcium aluminoferrite, and magnesium oxide.

In certain embodiments, the cement is selected from Portland cement, calcium aluminosilicate cement, and calcium sulfoaluminate cement.

The aggregate may comprise sand, gravel, rock, ground mineral powders, or a combination thereof. In some embodiments, the aggregate comprises a particle size no greater than about 4 mm.

In some embodiments, the mortar powder comprises, by weight about 10% to 50% cement, and about 50% to 90% aggregate. In certain embodiments, the mortar powder comprises, by weight about 20% to 40% cement, and about 60% to 80% aggregate.

In some embodiments, the mortar powder further comprises one or more admixtures. The one or more admixtures may be selected from supplementary cementitious material, fiber, water reducer, air entrainer, defoamer, shrinkage reducer, water repellent, accelerant, retarder, pumping aid, thickener, and any combination thereof.

In some embodiments, the mortar powder comprises about 10% to 30% cement, about 55% to 75% aggregate, and about 5% to 25% admixtures. In certain embodiments, the mortar powder comprises about 15% to 25% cement, about 60% to 70% aggregate, and about 10% to 20% admixtures.

In some embodiments, the mortar powder further comprises a hydroxide containing salt. The hydroxide containing salt may be selected from calcium hydroxide, sodium hydroxide, lithium hydroxide, potassium hydroxide, and magnesium hydroxide.

In embodiments of the invention, the one or more epoxies comprises a polymeric resin. In some embodiments, the one or more epoxies comprises a bisphenol-based epoxy. The bisphenol-based epoxy may be selected from bisphenol-A diglycidyl ether, novolac glycidyl ether, resorcinol diglycidyl ether, and any combination thereof.

In some embodiments, the one or more epoxies comprises a water-based epoxy.

In some embodiments, the one or more epoxies and the mortar powder are present in the mortar composition in a ratio of about 1:200 to 1:25 by weight. In certain embodiments, the one or more epoxies and the mortar powder are present in the mortar composition in a ratio of about 1:100 to 1:33 by weight.

In embodiments of the invention, the mortar composition further comprises one or more curing agents. In some embodiments, the one or more curing agents comprises a reactive amine. The reactive amine may be selected from an aliphatic reactive amine, cycloaliphatic reactive amine, and an aromatic reactive amine. In certain embodiments, the reactive amine comprises a water-based reactive amine.

In some embodiments, the one or more curing agent comprises an acid anhydride.

In some embodiments, the one or more curing agents comprise a hydroxide containing salt. The hydroxide containing salt may be selected from the group consisting of calcium hydroxide, sodium hydroxide, lithium hydroxide, potassium hydroxide, and magnesium hydroxide.

In some embodiments, the curing agent and the one or more epoxies are present in the mortar composition in a ratio of about 1:1 to 1:4 by weight. In certain embodiments, the curing agent and the one or more epoxies are present in the mortar composition in a ratio of about 1:2 to 1:3 by weight.

### BRIEF DESCRIPTION OF THE DRAWINGS

FIG. 1 shows a schematic of the 3D printing apparatus described in Example 1.

FIG. 2 shows a visual representation of the carriage path instructed by the G-code, as described in Example 1.

### DETAILED DESCRIPTION OF THE INVENTION

The practice of the present invention will employ, unless otherwise indicated, conventional techniques of at least materials science, civil engineering, and polymer science, which are within the skill of the art.

In order that the present invention can be more readily understood, certain terms are first defined. Additional definitions are set forth throughout the disclosure. Unless defined otherwise, all technical and scientific terms used herein have the same meaning as commonly understood by one of ordinary skill in the art to which this invention is related.

Any headings provided herein are not limitations of the various aspects or embodiments of the invention, which can be had by reference to the specification as a whole. Accordingly, the terms defined immediately below are more fully defined by reference to the specification in its entirety.

All of the references cited in this disclosure are hereby incorporated by reference in their entireties. In addition, any manufacturers' instructions or catalogues for any products cited or mentioned herein are incorporated by reference. Documents incorporated by reference into this text, or any teachings therein, can be used in the practice of the present invention. Documents incorporated by reference into this text are not admitted to be prior art.

### Definitions

The phraseology or terminology in this disclosure is for the purpose of description and not of limitation, such that the terminology or phraseology of the present specification is to be interpreted by the skilled artisan in light of the teachings and guidance.

As used in this specification and the appended claims, the singular forms “a,” “an,” and “the” include plural referents, unless the context clearly dictates otherwise. The terms “a” (or “an”) as well as the terms “one or more” and “at least one” can be used interchangeably.

Furthermore, “and/or” is to be taken as specific disclosure of each of the two specified features or components with or without the other. Thus, the term “and/or” as used in a phrase such as “A and/or B” is intended to include A and B, A or B, A (alone), and B (alone). Likewise, the term “and/or” as used in a phrase such as “A, B, and/or C” is intended to include A, B, and C; A, B, or C; A or B; A or C; B or C; A and B; A and C; B and C; A (alone); B (alone); and C (alone).

Wherever embodiments are described with the language “comprising,” otherwise analogous embodiments described in terms of “consisting of” and/or “consisting essentially of” are included.

Units, prefixes, and symbols are denoted in their Système International de Unites (SI) accepted form. Numeric ranges are inclusive of the numbers defining the range, and any individual value provided herein can serve as an endpoint for a range that includes other individual values provided herein. For example, a set of values such as 1, 2, 3, 8, 9, and 10 is also a disclosure of a range of numbers from 1-10, from 1-8, from 3-9, and so forth. Likewise, a disclosed range is a disclosure of each individual value encompassed by the range. For example, a stated range of 5-10 is also a disclosure of 5, 6, 7, 8, 9, and 10.

The term “3D printing” as used herein refers to a method of constructing a three dimensional object, building, or structural element by depositing, extruding, molding, or drawing a cement-based mortar. Examples of 3D printing include, but are not limited to, DIW and contour crafting.

The term “mortar” as used herein refers to a composition of cement, aggregate, and admixtures.

The term “cement” as used herein refers to an inorganic material that can be used to bind materials together. Cement may be hydraulic (binds due to a chemical reaction between dry ingredients and water) or non-hydraulic (binds without wet conditions or the use of water, typically due to a chemical reaction with carbon dioxide in the air).

The term “aggregate” as used herein refers to a constituent of mortar or concrete that serves as structural filler. Aggregate size differentiates concrete from mortar; concrete typically comprises fine and coarse aggregate, while mortar typically comprises only fine aggregate.

The term “admixture” as used herein refers to a constituent of mortar that serves to improve working or hardened properties.

The term “epoxy” as used herein refers to epoxy resin, or a preparation of epoxy resin.

The term “curing agent” as used herein refers to a species able to cross link epoxy, and may be a reactive amine or hydroxide-containing salt.

The term “reactive amine” herein refers to a curing agent that may be aliphatic, cycloaliphatic, or aromatic. In addition, the curing agent can be an amidoamine, polyamide, or Mannich base.

The term “hydroxide-containing salt” as used herein refers to a salt comprising an alkali or alkaline earth metal ionically bonded with a hydroxyl group. It may be generated as a product of cement hydration and can act as a curing agent.

The term “water-based” as used herein to characterize an epoxy or reactive amine refers to an epoxy or reactive amine that is soluble, dispersed in water, or dispersible in water. Furthermore, “water-based” entails a substance that is water-reducible, i.e., it remains a stable solution or dispersion when diluted with additional water.

### Methods of the Invention

The present invention relates to the use of mortar compositions for forming a structure through 3D printing. In one aspect, the present invention relates to methods for forming a structure through 3D printing comprising applying through a 3D printing apparatus one or more layers of a mortar composition comprising a mortar powder and one or more epoxies. In another aspect, the present invention relates to a mortar composition comprising a mortar powder and one or more epoxies for use in forming a structure through 3D printing.

In some embodiments, the structure may be any 3D structure that can be made, at least in part, by mortar, including buildings and structural elements of buildings (e.g., masonry units), as well as in clay ceramics.

In some embodiments, the 3D printing may be DIW or contour crafting.

The mortar powder can comprise a cement and an aggregate. In embodiments of the invention, the cement is a hydraulic cement. In some embodiments, the cement comprises calcium silicates (for example, tricalcium silicates (C₃S), dicalcium silicates (C₂S), or both) in amounts of at least about 50%, or at least about 60%, or at least about 70%, by weight of the cement; for example, about 50% to 85%, or about 50% to 80%, or about 55% to 85%, or about 60% to 85%, or about 60% to 80%, or about 65% to 80%, or about 70% to 80%, by weight of the cement. The cement may further comprise calcium aluminates (for example, tricalcium aluminates (C₃A), dicalcium aluminates (C₂A), or both), calcium aluminoferrite (C₄AF), and magnesium oxide.

In some embodiments, the cement may be Portland cement, calcium aluminosilicate cement (Ciment Fondu), or calcium sulfoaluminate cement (CSA Cement). In certain embodiments, the Portland cement may be either Type I, Type II, Type III, Type, IV, or Type V.

In some embodiments, the aggregate may comprise sand, gravel, rock, ground mineral powders, or a combination thereof. In certain embodiments, the aggregate comprises a particle size no greater than about 4 mm, or about 3 mm, or about 2 mm, or about 1 mm, in diameter.

The mortar powder may further comprise one or more admixtures. Admixtures serve to improve or modify the properties of mix designs so that they may have consistent performance when using local materials. Examples of admixtures that may be used in the mortar powder of the present invention include, but are not limited to, SCMs, fibers, water reducers, air entrainers, defoamers, shrinkage reducers, water repellents, accelerants, retarders, pumping aids, thickeners, and any combination thereof. The admixtures may be derived from natural sources or produced by specialty chemical manufacturers.

In some embodiments, the one or more admixtures may comprise an SCM. An SCM comprises materials that gain binding properties, also referred to as “pozzolanic activity,” when finely dispersed or dissolved in a preparation of mortar. The binding properties of these materials are realized when the SCM is exposed to an alkali environment, typically with calcium ions present (Winter, 2009). An SCM that may be used with the present invention includes, but is not limited to, silica fume, fly ash, blast slag, metakaolin, pumice, amorphous calcium aluminosilicate, and combinations thereof.

In some embodiments, the one or more admixtures may comprise fibers. Fibers comprise natural or synthetic materials and can reduce crack formation and limit crack size in a hardened specimen of mortar. Fibers may also improve the rheology properties of mortar when in a workable state. Fibers that may be used with the present invention include, but are not limited to, steel, nylon, polyethylene, polyamide fibers, concrete fibers, and combinations thereof.

In some embodiments, the one or more admixtures may comprise a water reducer, which is also known as a “plasticizer,” “super plasticizer,” or “high range water reducer.” A water reducer comprises natural or synthetic materials and is used to lower the water/cement (W/C) ratio of mortar while maintaining good working properties. The W/C ratio refers to the quantity of water added to a preparation of concrete or mortar. A low W/C ratio may result in mortar with higher strength properties once hardened. However, a low W/C ratio may result in mortar with poor working properties; often excess water is added in order to produce a workable mix design. A water reducer can improve the working properties of mortar while keeping a low W/C ratio. A water reducer that may be used with the present invention includes, but is not limited to, polycarboxylate ethers, lignosulfonates, hydroxycarboxylic acids, hydroxylated polymers, salts of melamine formaldehyde sulfonates, and combinations thereof. Particular examples of a water reducer for use with the present invention include ADVA 190 (WR Grace Co.), FLOWRIC PS (Nippon Paper Industries Inc.), and MasterRheobuild 375 (BASF GMBH).

In some embodiments, the one or more admixtures may comprise an air entrainer. An air entrainer comprises natural or synthetic materials and is used to increase air content in a preparation of mortar. Air may be introduced during mixing with water. Entrained air may lower the density of a preparation or hardened specimen of mortar. It is known in the art that hardened specimens of mortar with entrained air may have improved freeze/thaw durability; however, strength properties may be decreased. An air entrainer that may be used with the present invention includes, but is limited to, alkyl esters, diethanolamides, and combinations thereof. Particular examples of an air entrainer for use with the present invention include SITREN AirVoid 601 (Evonik AG) and Sika AIR (Sika AG).

In some embodiments, the one or more admixtures may comprise a defoamer. A defoamer comprises natural or synthetic materials and is used to decrease air content in a preparation of mortar. A defoamer performs in the opposite manner as air entrainers. A preparation or hardened specimen of mortar with decreased air content may have a higher density than its air entrained counterpart. It is known in the art that hardened specimens of mortar with decreased air content may have improved strength properties. A defoamer that may be used with the present invention includes, but is not limited to, acetylenic diols, polysiloxanes, and combinations thereof. Particular examples of a defoamer for use with the present invention include SITREN AirVoid 307 (Evonik AG), and X-Air P (Hexion Inc.).

In some embodiments, the one or more admixtures may comprise a shrinkage reducer. A shrinkage reducer comprises natural or synthetic materials and is used to prevent or inhibit hardened mortar from shrinking. Shrinkage over the lifespan of a hardened specimen of mortar may contribute to crack formation and shifting. A shrinkage reducer that may be used with the present invention includes, but is not limited to, polyoxyalkylene alkyl ethers, ethylene glycol derivatives, and combinations thereof. Particular examples of a shrinkage reducer for use with the present invention include Eclipse 4500 (GCP Technologies Inc.), Eucon SRA-XT (Euclid Chemical Co.), and MasterLife CRA 007 (BASF GMBH).

In some embodiments, the one or more admixtures may comprise a water repellent. A water repellant comprises natural or synthetic materials and is used to decrease water permeability of hardened mortar. It is known in the art that hardened specimens of mortar with decreased water permeability may have improved freeze/thaw durability. Additionally, mortar with water repellents may have improved resistance to efflorescence; leaching of salts from hydrated cement to the surface of the hardened specimen. A water repellent that may be used with the present invention includes, but is not limited to, colloidal silica, lithium silicate, octyl(triethoxy)silane, and combinations thereof. Particular examples of a water repellent for use with the present invention include Eucon HYDRAPEL 2.0 (Euclid Chemical Co.), and Sika CONTROL ASR (Sika AG).

In some embodiments, the one or more admixtures may comprise an accelerant. An accelerant comprises natural or synthetic materials and is used to speed up the hydration reaction cement undergoes when mixed with water. The speed of the hydration reaction may vary due to temperature; low temperatures slow down the reaction, and accelerants are sometimes added to normalize set time. An accelerant that may be used with the present invention includes, but is not limited to, calcium salts, sodium salts, thiocyanate compounds, alkanolamine (e.g., triethanolamine), and combinations thereof.

In some embodiments, the one or more admixtures may comprise a retarder. A retarder comprises natural or synthetic materials and is used to slow the hydration reaction cement undergoes when mixed with water. The speed of the hydration reaction may vary due to temperature; high temperatures speed up the reaction, and a retarder can be added to normalize the set time. A retarder that may be used with the present invention includes, but is not limited to, glucose, tartaric acid, sodium gluconate, and combinations thereof.

In some embodiments, the one or more admixtures may comprise a pumping aid. A pumping aid comprises natural or synthetic materials and is used to improve the flow properties of a preparation of mortar. These materials may be used in a preparation of mortar to produce a mix design with good pumping properties when still in a workable state. A pumping aid that may be used with the present invention includes, but is not limited to, vinyl acetate/ethylene polymers, polyvinyl alcohol, and combinations thereof. A pumping aid that may be used with the present invention includes, but is not limited to, a polyvinyl alcohol. Particular examples of a pumping aid for use with the present invention include VINNAPAS 4042H (Wacker Chemie AG) and PVA-18 (Shin Etsu Co., LTD.).

In some embodiments, the one or more admixtures may comprise a thickener. A thickener comprises natural or synthetic materials that improve the slump and consistency properties of a preparation of mortar. These materials may be used in a preparation of mortar to resist deformation and segregation once placed and allowed to harden. A thickener that may be used with the present invention includes, but is not limited to, celluloses (e.g., methyl hydroxyethyl cellulose), clays, gums, and combinations thereof. Particular examples of a thickener for use with the present invention include WALOCEL M 120-01 (Dow Inc.), Pangel S9 (Tolsa SA), and KELCO-CRETE (C.P. Kelco Inc.).

In some embodiments, the mortar powder may comprise, by weight:
(a) about 10% to 50% cement, or about 10% to 40% cement, or about 10% to 30% cement, or about 15% to 25% cement, or about 20% to 50% cement, or about 20% to 40% cement, or about 15% cement, or about 20% cement, or about 25% cement, or about 30% cement, or about 35% cement, or about 40% cement;
(b) about 50% to 90% aggregate, or about 50% to 80% aggregate, or about 55% to 75% aggregate, or about 60% to 70% aggregate, or about 60% aggregate, or about 65% aggregate, or about 70% aggregate, or about 75% aggregate, or about 80% aggregate, or about 85% aggregate; and
(c) about 0% to 25% admixtures, or about 5% to 25% admixtures, or about 5% to 20% admixtures, or about 10% to 20% admixtures, or about 10% admixtures, or about 15% admixtures, or about 20% admixtures.

In some embodiments, the mortar powder may further comprise a hydroxide containing salt, such as calcium hydroxide, sodium hydroxide, lithium hydroxide, potassium hydroxide, or magnesium hydroxide. In such embodiments, the mortar powder may comprise, by weight:
(a) about 5% to 30% cement, or about 10% to 30% cement, or about 15% to 25% cement, or about 15% cement, or about 20% cement, or about 25% cement;
(b) about 40% to 80% aggregate, or about 45% to 75% aggregate, or about 50% to 70% aggregate, or about 55% to 65% aggregate, or about 55% aggregate, or about 60% aggregate, or about 65% aggregate, or about 70% aggregate, or about 75% aggregate;
(c) about 5% to 25% admixtures, or about 10% to 20% admixtures, or about 10% admixtures, or about 15% admixtures, or about 20% admixtures; and
(d) about 1% to 15% hydroxide containing salt, or about 1% to 10% hydroxide containing salt, or about 5% hydroxide containing salt.

In some embodiments, the one or more epoxies comprise a polymeric resin. Resins with epoxide or oxirane functional groups may be capable of undergoing polymerization, sometimes called cross-linking, or curing (Petrie, 2006). Cross-linking typically occurs with the mixing or addition of an appropriate curing agent. Epoxy can also homopolymerize and cross-link with itself under appropriate conditions; homopolymerization has been observed as a side reaction to larger polymerization schemes involving curing agents. Epoxy is known for its robust physical properties, tenacious adhesion, and resistance to chemicals, which makes it useful for adhesives, coatings, and plastics.

The one or more epoxies for use with the present invention may be based on bisphenol, which is a petroleum-derived alcohol that is reacted with epichlorohydrin to yield a resin containing epoxide functional groups. Examples of a bisphenol-based epoxy for use with the present invention include, but are not limited to, bisphenol-A diglycidyl ether, novolac glycidyl ether, resorcinol diglycidyl ether, and combinations thereof. Particular examples of an epoxy for use with the present invention include D.E.R. 331 (Olin Inc.), Epikote 240 (Hexion Inc.), Araldite EPN 1139, and ERYSIS R.I.D.G.E. (Huntsman International LLC).

For the preparation of a solution of epoxy, typically organic solvents are used, such as xylene or butyl acetate. Epoxies are typically hydrophobic, and are typically insoluble in water. However, preparations of water-based epoxy have been conceived. Several methods have been devised to prepare a water-based epoxy.

In some embodiments, the one or more epoxies may be water-based. In certain embodiments, the one or more epoxies may be water-reducible, which means that it may be diluted with water and readily form a stable dispersion or mixture. In some embodiments, the one or more water-based epoxies may readily emulsify with compatible curing agents.

The one or more water-based epoxies for use with the present invention may comprise a Type 1, Type 2, Type 3, Type 5, or Type 7 water-based epoxy resin (Watkins et al., 2006). In some embodiments, the one or more water-based epoxies may comprise a Type 1 water-based epoxy resin, which comprises epoxy resin, surfactant, and water as a dispersion; fine epoxy droplets are stabilized by surfactant in water. Some examples of a Type 1 water-based epoxy resins include, EPIREZ 7521-WH-57, EPIREZ Resin 3510-W-60 (Hexion Inc.), Araldite PZ 3901 (Hunstman LLC), and D.E.R. 915 (Olin Inc.).

In some embodiments, the one or more water-based epoxies may comprise a Type 2 water-based epoxy resin, which comprises epoxy resin, cosolvent, and water. The cosolvent is capable of dissolving epoxy, and is miscible in water. An example of a Type 2 water-based epoxy resin is EPIREZ 3522-W-60 (Hexion Inc.).

In some embodiments, the one or more water-based epoxies may comprise a Type 3 water-based epoxy resin, which comprises epoxy resin and water-based acrylic resin as a dispersion. The acrylic resin is capable of stabilizing the epoxy in water. An example of a Type 3 water based epoxy is a dispersion of EPIREZ WD-510 (Hexion Inc.) with ETERSOL G1182 (Eternal Chemical Inc.).

In some embodiments, the one or more water-based epoxies may comprise a Type 5 or Type 7 water-based epoxy resin, which comprises epoxy resin adduct dispersed in water. An adduct is the partially cross-linked reaction product of epoxy and curing agent. The curing agent is soluble or miscible in water, solubilizing the epoxy with which it is partially reacted. Examples of Type 5/7 water-based epoxy resins include Ancarez AR555 (Evonik AG) and EPIREZ 6520-WH-53 (Hexion Inc.).

In some embodiments, the one or more water-based epoxies and the mortar powder may be in the composition in a ratio of about 1:200 to 1:25 by weight, or in a ratio of about 1:100 to about 1:33 by weight, or in a ratio of about 1:50 by weight.

The composition may further comprise one or more curing agents. In some embodiments, the one or more curing agents may comprise a reactive amine. Reactive amines are typically liquid, and can usually reach a full cure at ambient temperatures (Petrie, 2006).

In some embodiments, the one or more curing agents may comprise an aliphatic reactive amine. Examples of aliphatic reactive amines for use in the present invention include, but are not limited to, triethylenetetramine, diethylenetriamine, and a combination thereof. Other examples include Ancamine TETA (Evonik AG) and EPIKURE 3223 (Hexion Inc.).

In some embodiments, the one or more curing agents may comprise a cycloaliphatic reactive amine. Examples of cycloaliphatic reactive amines for use in the present invention include, but are not limited to isopherone diamine, para-diamino-dicyclohexyl-methane, and a combination thereof. Other examples include Vestamin IPD (Evonik AG) and Baxxodur EC 331 (BASF GMBH).

In some embodiments, the one or more curing agents may comprise an aromatic reactive amine. Examples of aromatic reactive amines for use in the present invention include, but are not limited to meta-xylylenediamine, meta-phenylenediamine, and a combination thereof. Another example includes Aradur 22 (Huntsman International LLC).

In some embodiments, the one or more curing agents may comprise a reactive amine that has been chemically modified, for example, by adduction or condensation. Other examples of chemically modified curing agents are amidoamines, polyamides, and Mannich bases.

In some embodiments, the one or more curing agents may comprise an amidoamine. An amidoamine is the reaction product between an amine and a fatty acid. Certain amidoamine curing agents for use with epoxy have been devised, where the amine in the reaction product is still capable of cross-linking. Examples of amidoamine curing agents include Chem Cure 135 (Cargill Inc.), EPIKURE 3046 (Hexion Inc.), and Ancamide 512 (Evonik AG).

In some embodiments, the one or more curing agents may comprise a polyamide. A polyamide is the reaction product between an amine and an acid. Preferably, this reaction occurs with a diacid and diamine. Polyamide curing agents for use with epoxy have been devised, where the amine in the reaction product is still capable of cross-linking. Examples of polyamide curing agents include EPIKURE 3164 (Hexion Inc.), Ancamide 805 (Evonik AG), and Aradur 450 (Huntsman International LLC).

In some embodiments, the one or more curing agents may comprise a Mannich base. A Mannich base is the product from the Mannich reaction, i.e., the condensation product between an amine, aldehyde, and carbon acid. Mannich base curing agents for use with epoxy have been devised, where the amine in the reaction product is still capable of cross-linking. Examples of Mannich base curing agents include Chem Cure 265 (Cargill Inc.), Aradur 14 (Huntsman International LLC), and EPIKURE 185 (Hexion Inc.).

In some embodiments, the one or more curing agents may comprise a water-based reactive amine curing agents, which can be used with water-based epoxies. Water-based curing agents typically comprise a reactive amine, which may be aliphatic, cycloaliphatic, or aromatic, and furthermore may be a chemically modified amine such as an amidoamine, polyamine, or Mannich base.

In some embodiments, the water-based reactive amine curing agents may also be water-reducible, i.e., they may be diluted with water and readily form a stable dispersion or mixture. In certain embodiments, a water-reducible, water-based reactive amine curing agent may further comprise a surfactant, water, and/or co-solvent. Furthermore, some preparations of water-based reactive amine curing agents can emulsify epoxy resins which are not water-based. Examples trade names of water-based reactive amine curing agents include Anquamine 360 and Anquamine 731 (Evonik AG), Aradur 340 (Huntsman International LLC), and EPIKURE 8530-W-75 (Hexion Inc.).

In some embodiments, the one or more curing agents may comprise an acid anhydride. An acid anhydride can initiate three reactions: (1) a reaction between an acid anhydride and water, which forms a diacid in a reversible process—this reaction may also be catalyzed by alcohols, or tertiary amines which react with epoxy to generate an alcohol; (2) a reaction between the diacid and epoxy, to cross-link, and additionally form an alcohol; and (3) a reaction between the alcohol formed by the epoxy reacting with the diacid, and another free epoxy to homopolymerize (Petrie, 2006). Acid anhydride curing agents can react at ambient temperature, however elevated temperatures are typically utilized. Typical curing temperature is between one 165° to 200° C. Examples of acid anhydride curing agents for use with the present invention include, but are not limited to, phthalic anhydride, benzophenone-3,3′,4,4′-tetracarboxylicdianhydride (BTDA), and combinations thereof. Additionally, some example tertiary amine and alcohol catalysts that can be used with the present invention are tris-2,4,6-dimethylaminomethyl phenol and benzyl alcohol.

It is understood that hydroxide ions may act like alcohols to react with epoxy to cross-link using a mechanism similar to acid anhydrides (Ohama et al., 2006). It can be generally understood that calcium hydroxide is able to cross-link epoxy, and calcium hydroxide produced from cement hydration is a curing agent. Furthermore, other hydroxide containing salts could be added to a composition of mortar to serve as curing agents for epoxy, including but not limited to: calcium hydroxide, sodium hydroxide, lithium hydroxide, potassium hydroxide and magnesium hydroxide.

In some embodiments, the curing agent and the one or more water-based epoxies may be in the composition in a ratio of about 1:1 to 1:4 by weight, or in a ratio of about 1:1 to about 1:3 by weight, or in a ratio of about 1:2 by weight.

In embodiments of the invention, the mortar composition additionally comprises water. Water may be present in the mortar composition in a ratio with the cement in the mortar powder of about 1:1 to 1:5, or about 1:1.5 to 1:4, or about 1:2 to 1:3, by weight.

The methods of the present invention can employ 3D printing apparatuses known in the art. Non-limiting examples of such printing are set forth in U.S. Pat. No. 11,230,032, which describes a cable-driven 3D printing apparatus; U.S. Patent Publication No. 2015/0300036, which describes a 3D printing apparatus optimized for the construction of towers and columns; U.S. Pat. No. 7,814,937, which describes a 3D printing apparatus with improved device mobility and setup; and EP Patent No. 2079656, which describes a gantry style 3D printing apparatus; all of which are incorporated herein by reference in their entireties.

In some embodiments, the mortar composition is prepared by mixing the mortar powder and epoxy, or the mortar powder and epoxy and curing agent, with water; and the mortar composition is then applied, for example, pumped, through the 3D printing apparatus.

In some embodiments, the mortar composition is prepared by first mixing the mortar powder with water, or mixing the mortar powder and hydroxide containing salt with water. The mortar powder-water mixture is applied through the 3D printing apparatus. The epoxy, or the epoxy and curing agent, optionally with one or more admixtures, are combined with the mortar powder-water mixture as the mortar powder-water mixture is being applied, using a mechanical element integrated into the 3D printing apparatus. The mechanical element may comprise an auger, static mixer, or hopper.

### EXAMPLES

### Example 1

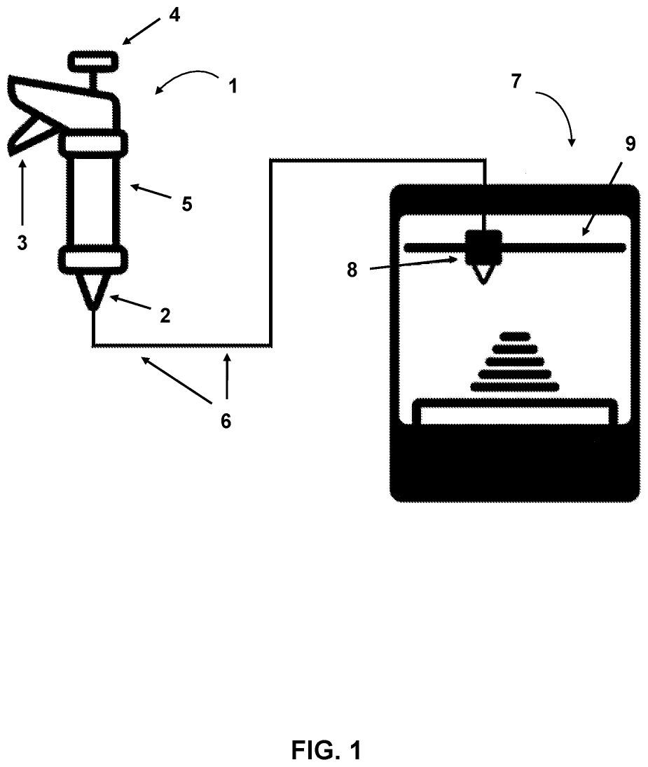

A mortar composition was prepared and used in a surrogate 3D printing apparatus, in accordance with embodiments of the invention. The 3D printing apparatus was created by modifying consumer grade equipment. As shown in FIG. 1, the equipment comprises a sausage pack adhesive applicator 1 with accompanying nozzle 2, a fused deposition modeling (FDM) 3D printer 7, tubing 6 connecting the nozzle 2 to the FDM 3D printer 7, and a custom tubing mount 8 and G-code instructions for the FDM printer 7.

This experimental setup represents a small scale 3D printing apparatus for construction applications. The sausage pack adhesive applicator 1 represents the pump and hosing components of the 3D printing apparatus, and the modified FDM printer 7 represents the plotting components.

Preparations of mortar was extruded through the nozzle 2 with 1.5 feet of 0.5-inch inner diameter, 0.75-inch outer diameter nylon braided polyvinyl chloride (PVC) plastic tubing 6.

The FDM 3D printer 7 used was a Creality Ender 3v2 (Shenzhen Creality 3D Technology Co, Ltd.). This printer 7 was intended to use thermoplastic filament such as poly-lactic acid (PLA) or acrylonitrile butadiene styrene (ABS). This printer 7 was modified by removing the hot end (filament heating element) and accompanying fans, tubing, and wiring. Furthermore, the filament extruder stepper motor and wiring for the heated printer bed were removed.

A custom tubing mount 8 was affixed to the carriage of the 3D printer 7, where the hot end once resided. The tubing mount 8 was designed to hold the end of the PVC tubing 6 on the sausage pack adhesive applicator 1.

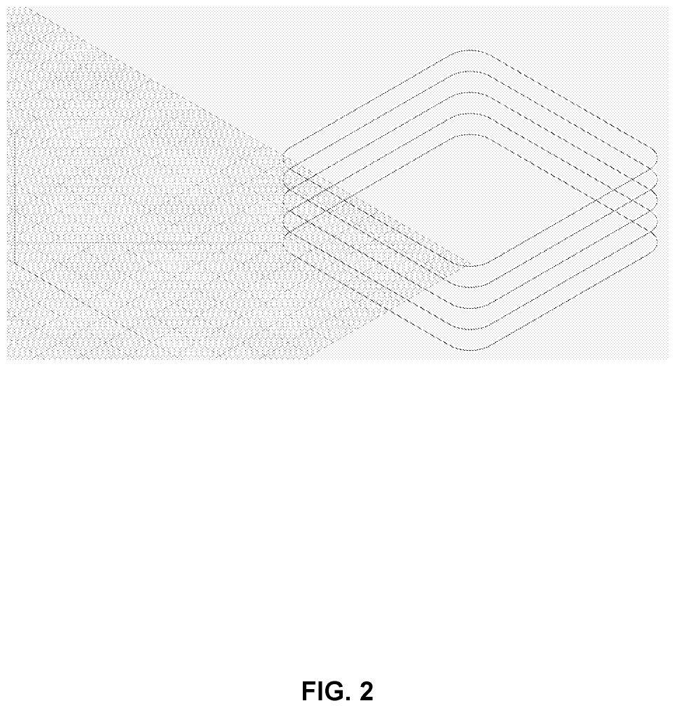

The onboard software for the 3D printer 7 follows instructions from the G-code computer language. More specifically, the Creality 3D printer utilized for demonstrating the invention follows instructions from the Marlin flavor of G-Code. The G-code used for the demonstration of the invention provides instructions to move the carriage 9 in the pattern of a 100 mm×100 mm square, with curved corners following a 15-mm radius. This pattern was repeated at various heights to deposit five layers of 3D printing mortar atop one another. The layer height was 8 mm. A visual representation of the carriage path which the G-code instructs is displayed in FIG. 2.

The mortar composition comprised mortar powder, which comprised a cement, aggregate, and admixtures; an epoxy, which was a liquid bisphenol A-based resin; and a curing agent, which was a reactive amine. The quantity of each component is provided in Table 1.

TABLE 1
Components of the mortar composition.

| Component | | | Quantity (%) |
|---|---|---|---|
| Mortar | Cement | TXI Type I/II Portland cement | 12.264 |
| Powder | | (Martin Marietta Materials Inc.) | |
| | Aggregate: | Quikrete All-Purpose Sand, sieved | 66.698 |
| | Sand | (Quickrete Holdings Inc.) | |
| | Admixture, SCM: | VCAS 160 | 11.320 |
| | Vitrified calcium | (Vitro Minerals Inc.) | |
| | aluminosilicate | | |
| | Admixture, fiber: | 3-mm anti-crack concrete fibers | 0.094 |
| | Concrete fibers | (Owens Corning Inc.) | |
| | Admixture, water reducer: | Melflux 2651F | 3.019 |
| | Modified polycarboxylic | (BASF GMBH) | |
| | ether | | |
| | Admixture, retarder: | Sodium gluconate | 0.472 |
| | Sodium gluconate | (Eisen-Golden Laboratories) | |
| | Admixture, pumping aid: | Tyvolis PVA 18 | 0.377 |
| | Polyvinyl alcohol | (Shin Etsu Co., LTD.) | |
| | Admixture, thickener: | Tylose MHS 150003 P4 | 0.094 |
| | Modified methyl | (Shin Etsu Co., LTD.) | |
| | hydroxyethyl cellulose | | |
| | powder | | |
| Epoxy | Bisphenol-A diglycidyl | Epon 828 | 3.773 |
| | ether epoxy resin with | (Hexion Inc) | |
| | weight per epoxide of | | |
| | 185-192 | | |
| Curing Agent | Aliphatic amidoamine | Ancamide 500 | 1.889 |
| | | (Evonik AG) | |

To prepare the mortar composition, water was first added to a mixing vessel, to which then epoxy resin, mortar powder, and curing agent were added. Using a drill with a propeller-style mixing shaft, all components were mixed until homogenous, for about three minutes, resulting in a mortar paste.

The mixed mortar composition was loaded into the metal chamber 5 of the sausage pack adhesive applicator 1. The trigger 3 of the applicator 1 was depressed so that the plunger 4 would extrude mortar through the nozzle 2 and attached tubing 6. This was performed to prime the nozzle 2 and tubing 6 with mortar. The tubing 6 was then inserted into the tubing mount 8 affixed to the 3D printer's carriage 9. The trigger 3 of the sausage pack applicator 1 was depressed while simultaneously activating the 3D printer 7 to execute the loaded G-code. The trigger 3 of the sausage pack applicator 1 remained depressed for the duration of the time the 3D printer 7 needed to move in the pattern instructed but the G-code, resulting in a deposited layers of mortar in the pattern dictated by the G-code.

Table 2 lists qualitative observations on the properties of flow, slump, and consistency of the mortar composition and its use in printing a structure.

TABLE 2
Observations on the properties of the mortar composition.

| Property | Remarks |
|---|---|
| Flow | Extruded material flows evenly with no lumps, and without |
| | straining equipment. |
| Slump | No deformation of deposited layers was observed as |
| | subsequent layers were deposited atop the printed structure. |
| Consistency | No segregation of constituents or water bleeding/laitance |
| | observed. |

These results indicated that the composition can be used effectively as a mortar for 3D printing applications.

### Example 2

A mortar composition is prepared in accordance with embodiments of the invention. Table 3 provides a mortar composition comprising a mortar powder, which comprises a cement, aggregate, and admixtures; and an epoxy, which is a liquid bisphenol A-based resin.

TABLE 3
Components of the mortar composition.

| Component | | | Quantity (%) |
|---|---|---|---|
| Mortar | Cement | TXI Type I/II Portland cement | 12.500 |
| Powder | | (Martin Marietta Materials Inc.) | |
| | Aggregate: | Quikrete All-Purpose Sand, sieved | 67.980 |
| | Sand | (Quickrete Holdings Inc.) | |
| | Admixture, SCM: | VCAS 160 | 11.538 |
| | Vitrified calcium | (Vitro Minerals Inc.) | |
| | aluminosilicate | | |
| | Admixture, fiber: | 3-mm anti-crack concrete fibers | 0.096 |
| | Concrete fibers | (Owens Corning Inc.) | |
| | Admixture, water reducer: | Melflux 2651F | 3.076 |
| | Modified polycarboxylic | (BASF GMBH) | |
| | ether | | |
| | Admixture, retarder: | Sodium gluconate | 0.484 |
| | Sodium gluconate | (Eisen-Golden Laboratories) | |
| | Admixture, pumping aid: | Tyvolis PVA 18 | 0.384 |
| | Polyvinyl alcohol | (Shin Etsu Co., LTD.) | |
| | Admixture, thickener: | Tylose MHS 150003 P4 | 0.096 |
| | Modified methyl | (Shin Etsu Co., LTD.) | |
| | hydroxyethyl cellulose | | |
| | powder | | |
| Epoxy | Bisphenol-A diglycidyl | Epon 828 | 3.846 |
| | ether epoxy resin with | (Hexion Inc) | |
| | weight per epoxide of | | |
| | 185-192 | | |

To prepare the mortar composition, water is first added to a mixing vessel, to which then epoxy resin and mortar powder are added. Using a drill with a propeller-style mixing shaft, all components are mixed until homogenous, for about three minutes, resulting in a paste. The mortar composition is loaded into the 3D printing apparatus.

Table 4 lists qualitative observations on the properties of flow, slump, and consistency of the mortar composition and its use in printing a structure.

TABLE 4
Observations on the properties of the mortar composition.

| Property | Remarks |
|---|---|
| Flow | Extruded material flows evenly with no lumps, and without |
| | straining equipment. |
| Slump | No deformation of deposited layers was observed as |
| | subsequent layers were deposited atop the printed structure. |
| Consistency | No segregation of constituents or water bleeding/laitance |
| | observed. |

### Example 3

A mortar composition is prepared in accordance with embodiments of the invention. Table 5 provides a mortar composition comprising a mortar powder, which comprises a cement, aggregate, and admixtures; an epoxy, which is a liquid bisphenol A-based resin, and a curing agent, which is calcium hydroxide.

TABLE 5
Components of the mortar composition.

| Component | | | Quantity (%) |
|---|---|---|---|
| Mortar | Cement | TXI Type I/II Portland cement | 12.500 |
| Powder | | (Martin Marietta Materials Inc.) | |
| | Aggregate: | Quikrete All-Purpose Sand, sieved | 67.307 |
| | Sand | (Quickrete Holdings Inc.) | |
| | Admixture, SCM: | VCAS 160 | 11.538 |
| | Vitrified calcium | (Vitro Minerals Inc.) | |
| | aluminosilicate | | |
| | Admixture, fiber: | 3-mm anti-crack concrete fibers | 0.096 |
| | Concrete fibers | (Owens Corning Inc.) | |
| | Admixture, water reducer: | Melflux 2651F | 3.076 |
| | Modified polycarboxylic | (BASF GMBH) | |
| | ether | | |
| | Admixture, retarder: | Sodium gluconate | 0.484 |
| | Sodium gluconate | (Eisen-Golden Laboratories) | |
| | Admixture, pumping aid: | Tyvolis PVA 18 | 0.384 |
| | Polyvinyl alcohol | (Shin Etsu Co., LTD.) | |
| | Admixture, thickener: | Tylose MHS 150003 P4 | 0.096 |
| | Modified methyl | (Shin Etsu Co., LTD.) | |
| | hydroxyethyl cellulose | | |
| | powder | | |
| Epoxy | Bisphenol-A diglycidyl | Epon 828 | 3.846 |
| | ether epoxy resin with | (Hexion Inc) | |
| | weight per epoxide of | | |
| | 185-192 | | |
| Curing agent | Calcium hydroxide | Slaked lime | 0.673 |

To prepare the mortar composition, water is first added to a mixing vessel, to which then epoxy resin and mortar powder are added. Using a drill with a propeller-style mixing shaft, all components are mixed until homogenous, for about three minutes, resulting in a paste. The mortar composition is loaded into the 3D printing apparatus.

Table 6 lists qualitative observations on the properties of flow, slump, and consistency of the mortar composition and its use in printing a structure.

TABLE 6
Observations on the properties of the mortar composition.

| Property | Remarks |
|---|---|
| Flow | Extruded material flows evenly with no lumps, and without |
| | straining equipment. |
| Slump | No deformation of deposited layers was observed as |
| | subsequent layers were deposited atop the printed structure. |
| Consistency | No segregation of constituents or water bleeding/laitance |
| | observed. |

### REFERENCES

EDWARD PETRIE, “Epoxy Adhesive Formulations,” 2006, pg 71-84, nv, McGraw-Hill, United States of America.
MICHAEL WATKINS, ET AL., “Formulating High-Performance Waterborne Epoxy Coatings,” Sep. 11-12, 2006, np, nv, Thermoset Resin Formulators Association at the Hyatt Regency, Montréal Québec Canada.
NICK WINTER, “Understanding Cement: An Introduction to Cement Production, Cement Hydration, and Deleterious Processes in Concrete,” 2009, pg 84-99, nv, WHID Microanalysis Consultants LTD, Suffolk United Kingdom.
LOTFI ROMDHANE, SAMEH EL-SAYEGH, “3D Printing in Construction: Benefits and Challenges,” International Journal of Structural and Civil Engineering Research, November 2020, np, Vol 9 No 4, Creative Commons License (CC BY-NC-ND 4.0).

What is claimed is:

1. A method for forming a structure through three-dimensional (3D) printing, the method comprising applying through a 3D printing apparatus one or more layers of a mortar composition,
wherein the mortar composition comprises a mortar powder and one or more epoxies.

2. A mortar composition comprising a mortar powder and one or more epoxies for use in forming a structure through three-dimensional printing.

3. The method or mortar composition of claim 1 or 2, wherein the mortar powder comprises cement and aggregate.

4. The method or mortar composition of claim 3, wherein the cement comprises a hydraulic cement.

5. The method or mortar composition of claim 3 or 4, wherein the cement comprises at least about 50% calcium silicates by weight.

6. The method or mortar composition of claim 5, wherein the cement comprises at least about 60% calcium silicates by weight.

7. The method or mortar composition of claim 5 or 6, wherein the cement further comprises calcium aluminates, calcium aluminoferrite, and magnesium oxide.

8. The method or mortar composition of any one of claims 3-7, wherein the cement is selected from Portland cement, calcium aluminosilicate cement, and calcium sulfoaluminate cement.

9. The method or mortar composition of any one of claims 3-8, wherein the aggregate comprises sand, gravel, rock, ground mineral powders, or a combination thereof.

10. The method or mortar composition of any one of claims 3-9, wherein the aggregate comprises a particle size no greater than about 4 mm.

11. The method of mortar composition or any one of claims 3-10, wherein the mortar powder comprises, by weight about 10% to 50% cement, and about 50% to 90% aggregate.

12. The method of mortar composition or claim 11, wherein the mortar powder comprises, by weight about 20% to 40% cement, and about 60% to 80% aggregate.

13. The method or mortar composition of any one of claims 3-12, wherein mortar powder further comprises one or more admixtures.

14. The method or mortar composition of claim 13, wherein the one or more admixtures is selected from the group consisting of a supplementary cementitious material, fiber, water reducer, air entrainer, defoamer, shrinkage reducer, water repellent, accelerant, retarder, pumping aid, thickener, and any combination thereof.

15. The method or mortar composition of claim 13 or 14, wherein the mortar powder comprises about 10% to 30% cement, about 55% to 75% aggregate, and about 5% to 25% admixtures.

16. The method or mortar composition of claim, 15, wherein the mortar powder comprises about 15% to 25% cement, about 60% to 70% aggregate, and about 10% to 20% admixtures.

17. The method or mortar composition of any one of claims 3-16, wherein the mortar powder further comprises a hydroxide containing salt.

18. The method or mortar composition of claim 17, wherein the hydroxide containing salt is selected from the group consisting of calcium hydroxide, sodium hydroxide, lithium hydroxide, potassium hydroxide, and magnesium hydroxide.

19. The method or mortar composition of any one of claims 1-18, wherein the one or more epoxies comprises a polymeric resin.

20. The method or mortar composition of claim 19, wherein the one or more epoxies comprises a bisphenol-based epoxy.

21. The method or mortar composition of claim 20, wherein the bisphenol-based epoxy is selected from the group consisting of bisphenol-A diglycidyl ether, novolac glycidyl ether, resorcinol diglycidyl ether, and any combination thereof.

22. The method or mortar composition of claim 19, wherein the one or more epoxies comprises a water-based epoxy.

23. The method or mortar composition of any one of claims 1-22, wherein the one or more epoxies and the mortar powder are present in the mortar composition in a ratio of about 1:200 to 1:25 by weight.

24. The method or mortar composition of claim 23, wherein the one or more epoxies and the mortar powder are present in the mortar composition in a ratio of about 1:100 to 1:33 by weight.

25. The method or mortar composition of any one of claims 1-24, wherein the mortar composition further comprises one or more curing agents.

26. The method or mortar composition of claim 25, wherein the one or more curing agents comprises a reactive amine.

27. The method or mortar composition of claim 26, wherein the reactive amine is selected from the group consisting of an aliphatic reactive amine, cycloaliphatic reactive amine, and an aromatic reactive amine.

28. The method or mortar composition of claim 26 or 27, wherein the reactive amine comprises a water-based reactive amine.

29. The method or mortar composition of claim 25, wherein the one or more curing agent comprises an acid anhydride.

30. The method or mortar composition of claim 25, wherein the one or more curing agents comprise a hydroxide containing salt.

31. The method or mortar composition of claim 30, wherein the hydroxide containing salt is selected from the group consisting of calcium hydroxide, sodium hydroxide, lithium hydroxide, potassium hydroxide, and magnesium hydroxide.

32. The method or mortar composition of any one of claims 25-31, wherein the curing agent and the one or more epoxies are present in the mortar composition in a ratio of about 1:1 to 1:4 by weight.

33. The method or mortar composition of claim 32, wherein the curing agent and the one or more epoxies are present in the mortar composition in a ratio of about 1:2 to 1:3 by weight.
